(19) United States
(12) Patent Application Publication
(10) Pub. No.: US 2010/0101127 A1
(43) Pub. Date: Apr. 29, 2010

(54) LIGHT EMITTING DIODE (LED) ROAD SIGN PLATE

(75) Inventor: Yi-Qun CHEN, Taichung City (TW)

Correspondence Address: EGBERT LAW OFFICES, 412 MAIN STREET, 7TH FLOOR, HOUSTON, TX, 77002, US

(73) Assignee: SAFETY TRAFFIC EQUIPMENT Co., LTD., Taichung City (TW)

(21) Appl. No.: 12/567,760

(22) Filed: Sep. 26, 2009

(30) Foreign Application Priority Data
Oct. 27, 2008 (TW) 097219101

(51) Int. Cl. G09F 13/04; F21V 1/00; F21L 4/00; G09F 13/16

(52) U.S. Cl. 40/582; 362/235; 362/183; 40/541

(57) ABSTRACT

An improved light emitting diode (LED) road sign plate includes a plate seat, fixed mount, light guide plate, LED lights and graphical text shield. The fixed mount is provided with grooved rail. Several LED lights are embedded into the holding tank, and the light guide plate adhered with graphical text shield is incorporated into the grooved rail. The LED light source emits rays towards the center, and the opening is sealed by the adhesive tape. After being energized, a few LED lights emit light sources for the central graphical road signs, then the light guide plate makes its uniform rays penetrate the graphical text shield for outwards irradiation and clear visualization of the graphical road signs, thus saving the electricity and extending the service life with better assembly.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light emitting diode (LED) road sign plate, and more particularly to an innovative sign plate, which arranges a frame around the plate seat by a fixed mount, assembles the light guide plate into the grooved rail of the fixed mount and places several LED lights into the holding tank, enabling the uniform irradiation of the rays for visualization of the graphical texts on the road signs.

2. Description of Related Art Including Information Disclosed Under 37 CFR 1.97 and 37 CFR 1.98

The common road signs are generally categorized into two types: metal-plate and lamp-box road signs. The metal-plate road signs allow the graphical texts to be adhered onto a plate screwed securely onto lamp posts and traffic light poles. As a passive component, it can reflect visibly the graphical texts only through lighting, but it is widely used due to its very simple construction. The lamp-box road signs permit the graphical texts to be adhered onto an acryl plate bolted onto the front of a box, wherein some connecting lines and fluorescent lamps or cold-cathode tubes or T5 lamps (energy-saving lamps) are provided for projection of uniform rays. As an active component, it can reflect visibly the graphical texts from the internally transmitted light sources. It is mainly used in urban areas due to a larger power input as required.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique and improved LED road sign plate of the present invention, several LED lights are embedded into the holding tank, and the light guide plate, which is adhered with graphical text shield, is incorporated into the grooved rail. After being energized, a few LED lights emit light sources for the central graphical road signs, then the light guide plate make its uniform rays penetrate the graphical text shield for outwards irradiation and clear visualization of the graphical road signs, thus saving the electricity and extending the service life with higher resolution.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of the present invention.

FIG. 2 is an assembled perspective view of the present invention.

FIG. 3 is an assembled sectional view of the present invention.

FIG. 4 is a detailed sectional view of the light guide plate of the present invention.

FIG. 5 is a perspective view of the assembly of the present invention.

FIG. 6 is a schematic view of the present invention, showing the plate seat and the fixed mount formed into a grooved rail.

FIG. 7 is a schematic view of the present invention, showing the LED lights sealed by adhesive tape.

FIG. 8 is another perspective view of an application of the fixed mount of the present invention.

FIG. 9 is another perspective view of an application of the fixed mount of the present invention.

### DETAILED DESCRIPTION OF THE INVENTION

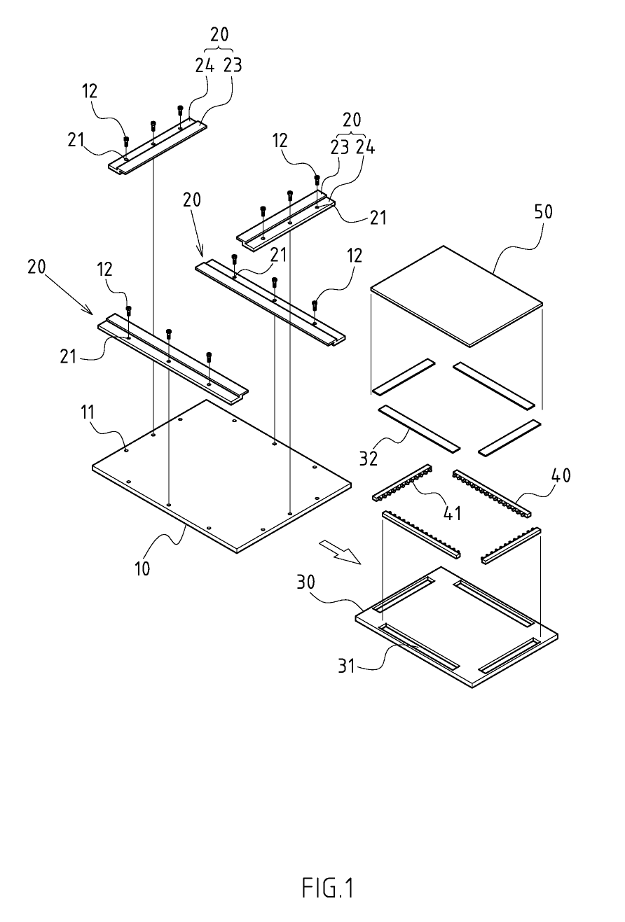

Referring to FIGS. 1, 2, 3, and 5, it mainly comprises a plate seat 10, fixed mount 20, light guide plate 30, a few rows of LED lights 40 and a graphical text shield 50. The fixed mount 20 of the preferred embodiment is a spliced mount. The plate seat 10 is a large plane, around which a few screw holes 11 are set and aligned separately to the through-hole 21 of the fixed mount 20. The fixed mount 20 is of a terraced pattern. Several through-holes 21 set on the lower plate 24 of the fixed mount 20 are aligned with the screw hole 11 of the plate seat 10. A grooved rail 22 is formed between the upper plate 23 of the fixed mount 20 and the plate seat 10, allowing for embedding of the assembled light guide plate 30, LED lights 40 and graphical text shield 50. One or several holding tanks 31 are opened around the light guide plate 30, so that several LED lights 40 are embedded for inwards irradiation. After being sealed by adhesive tape 32, the lateral rays can be guided to the central upfront, while high-reflectivity ink dots 33 of different sizes and densities are added onto the bottom, such that the incident rays are scattered and penetrated out of the light guide plate 30 for uniform brightness. Furthermore, a reflector board 34 is placed underneath to reflect the rays and increase the availability. A plurality of LED light sources 41 is mounted onto a row of LED lights 40 and distributed in parallel onto the circuit. The LED light source 41 is a white-light LED or yellow-light LED. Graphical road signs are centrally adhered onto a graphical text shield 50 and closely covered onto the light guide plate 30. Besides, the reflective film is adhered onto the graphical road signs, enabling the rays to be transmitted outwards while protecting the internal surface and reflecting external rays.

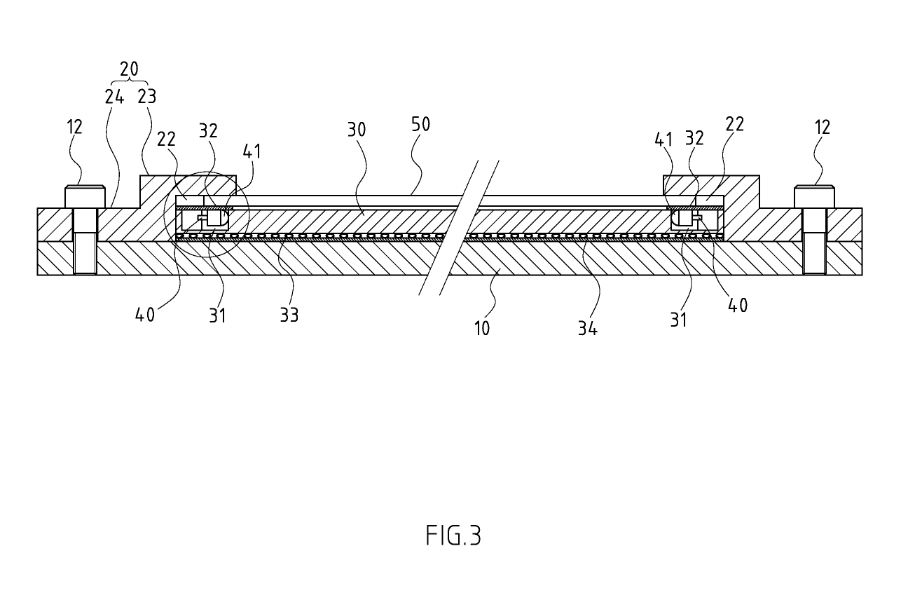

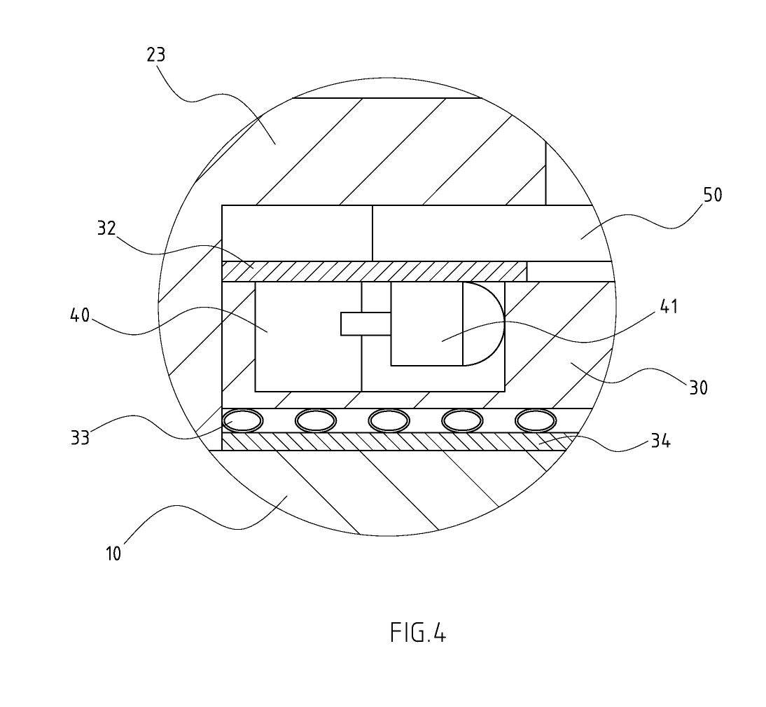

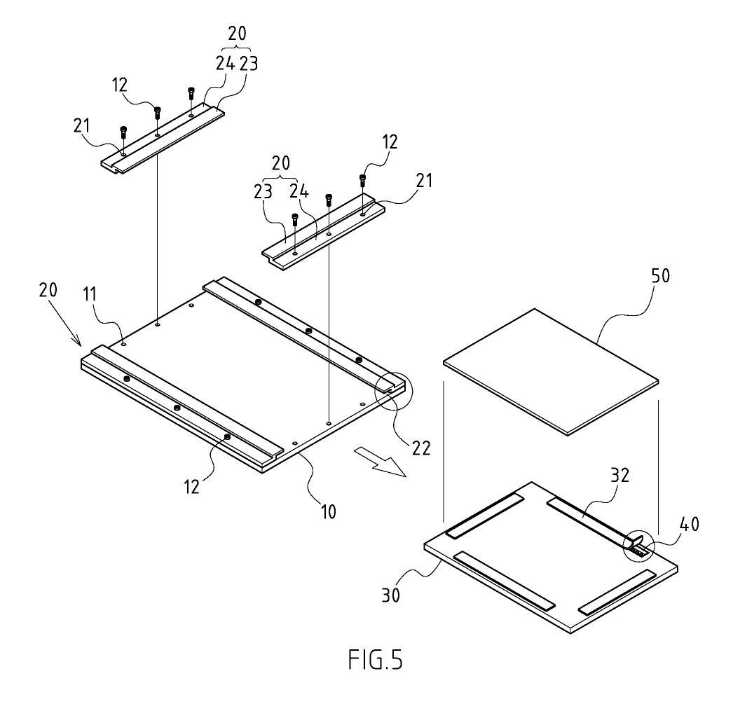

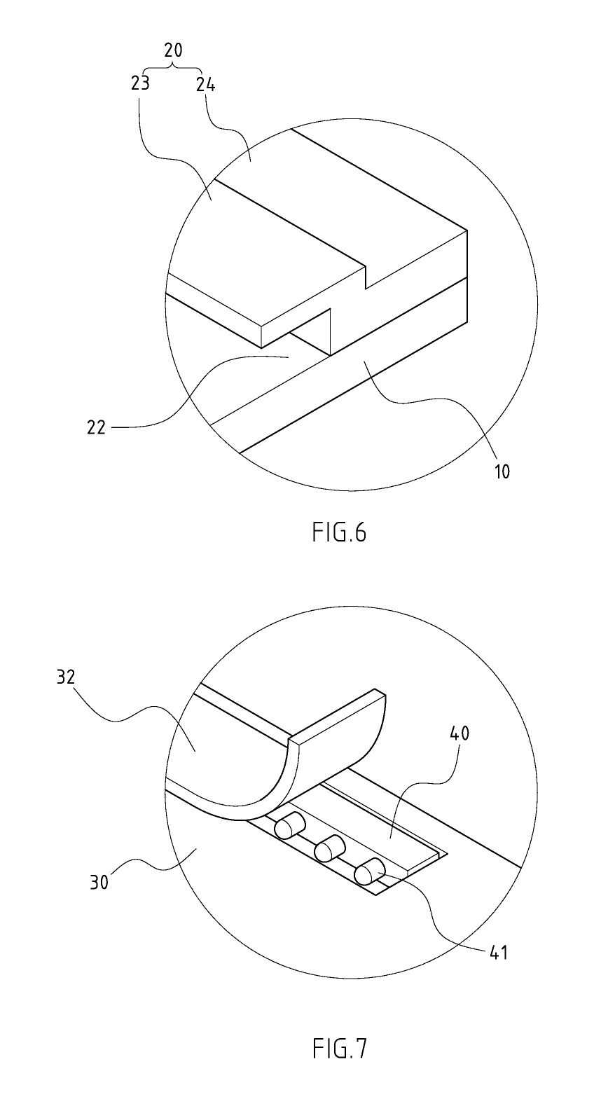

Referring to FIGS. 3, 5, 6 and 7, the fixed mount 20 is of a spliced pattern. The plate seat 10 and two symmetrical fixed mounts 20 penetrate via a bolt 12 the through-hole 21, and are then bolted into the screw hole 11. A few LED lights 40 are separately placed into the holding tank 31 of the light guide plate 30. The opening of the holding tank 31 is sealed by the adhesive tape 32 to form a closed space, and after a graphical text shield 50 is closely covered onto the plate, two symmetrical ends are slidably embedded along the grooved rail 22, then other fixed mounts 20 are bolted onto the plate seat 10, and pressed around the light guide plate 30 to form a frame covering the adhesive tape for aesthetical effect. After being energized, a few LED lights 40 emit light sources for the central graphical road signs, then the light guide plate 30 make its uniform rays penetrate the graphical text shield 50 for outwards irradiation, thereby saving the electricity and extending the service life for more practical benefits under the same area and illumination.

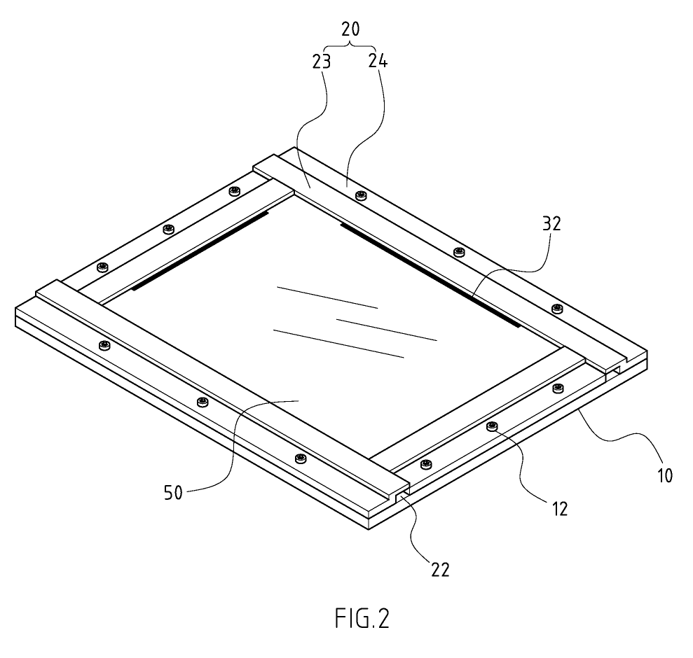

Referring to FIGS. 2 and 5, the existing metal-plate road boards are taken as a plate seat 10, which is fabricated and assembled with existing materials in the same sequence mentioned above. In addition to reduction of material cost, this can improve the driving safety by converting the passive road signs into active ones. With the use of LED light source 41 featuring low voltage, low current and conversion loss, at least a LED light 40 can be configured into the holding tank 31, where necessary, and solar panels or small-sized wind turbines, etc, are provided for autonomous power supply, without need of remote power supply for improved availability. During the period of maintenance, the bolts 12 around the frame are firstly loosened to remove the lower fixed mount 20, and then take out the assembled light guide plate 30 for replacement or repair. In the case of power shut-off or failure of LED light source 41, the graphical road signs on the graphical text shield 50 are adhered with reflective film, which can reflect the rays from the vehicle or other residual lights so as to prevent the functional loss of indication as a passive road sign.

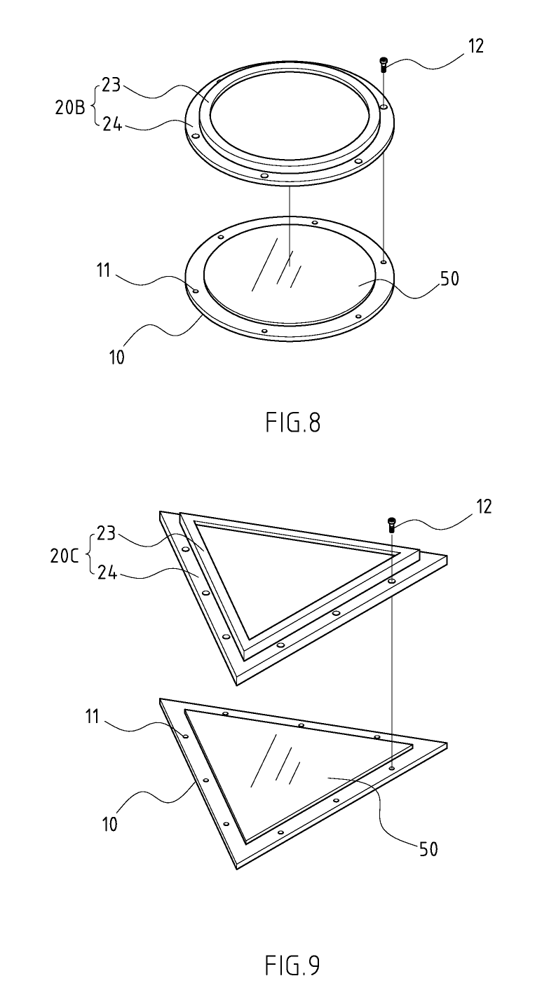

Referring to FIGS. 8 and 9, the fixed mount 20 is of a prefabricated frame, whereby a few LED lights 40 are embedded into the holding tank 31, and the light guide plate 30 adhered with graphical text shield 50 is fixed on the plate seat 10. Then, the grooved rails 22 of the prefabricated fixed mount 20 are aligned and screwed onto the plate seat 10 for positioning of the assembly.

Referring to FIGS. 1 and 2, the plate seat 10 and fixed mount 20 of the preferred embodiment are of a rectangular shape. Referring to FIG. 8, the plate seat 10 and the fixed mount 20B are of a round shape. Referring to FIG. 9, the plate seat 10 and the fixed mount 20C are of a triangular shape. Additionally, the plate seat and the fixed mount are also designed into other shapes such as an octagon.

Although the invention has been explained in relation to its preferred embodiment, it is to be understood that many other possible modifications and variations can be made without departing from the spirit and scope of the invention as hereinafter claimed.

1. A light emitting diode (LED) road sign plate, comprising:
a plate seat, having a large plane and a plurality of screw holes set around said plate seat;
a fixed mount, having a terraced pattern, being defined with upper and lower plates and being provided with a grooved rail, the lower plate having a plurality of through-holes set on the lower plate;
a light guide plate, guiding lateral rays to a central plate with an upfront viewing angle, said light guide plate having a plurality of holding tanks sealed by adhesive tape set around the light guide plate;
a LED light, being comprised of a plurality of LED light sources assembled onto a circuit; and
a graphical text shield having a center for graphical road signs adhered thereon;
wherein the LED lights are embedded into the holding tank, wherein the light guide plate, adhered with graphical text shield, is incorporated into the grooved rail, wherein, after being energized, at least one LED lights emits light sources for the central graphical road signs, then the light guide plate makes uniform rays penetrate the graphical text shield for outwards irradiation and clear visualization of the graphical road signs, thus saving the electricity and extending the service life with higher resolution.

2. The road sign plate defined in claim 1, wherein the LED light source is comprised of a white-light LED.

3. The road sign plate defined in claim 1, wherein the LED light sources are supplied from solar panels or small-sized wind turbines for autonomous power supply; or wherein remote external supply is provided.

4. The road sign plate defined in claim 1, wherein high-reflectivity ink dots of different sizes and densities are added onto the bottom of the light guide plate, such that the incident rays are scattered and penetrated out of the light guide plate, and wherein a reflector board is placed underneath to reflect the rays.

5. The road sign plate defined in claim 1, wherein the existing metal-plate road boards are taken as a plate seat, being fabricated and assembled with existing materials in the same sequence.

6. The road sign plate defined in claim 1, wherein the graphical road sign is adhered with reflective film.

7. The road sign plate defined in claim 1, wherein the fixed mount is comprised of a spliced pattern to form a frame, the fixed mount defining the grooved rail on the plate seat, several LED lights being embedded into the holding tank, while the light guide plate covered with graphical text shield is laterally slid into the grooved rail and then a plurality of fixed mounts are screwed securely.

8. The road sign plate defined in claim 1, wherein the fixed mount is comprised of a prefabricated frame, whereby a few LED lights are embedded into the holding tank, and wherein the light guide plate adhered with graphical text shield is fixed on the plate seat, the grooved rails of the prefabricated fixed mount being aligned and screwed onto the plate seat for positioning purpose.

9. The road sign plate defined in claim 1, wherein the plate seat is available with either of the following shapes: rectangular, round, triangular or octagonal shapes.
